(19) United States
(12) Patent Application Publication
(10) Pub. No.: US 2003/0122506 A1
(43) Pub. Date: Jul. 3, 2003

(54) Discharge lamp lighting apparatus

(75) Inventors: Masahiko Kamata, Kanagawa-ken (JP); Keiichi Shimizu, Kanagawa-ken (JP); Masahiro Sugiyama, Shizuoka-ken (JP); Katsuyuki Kobayashi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOSHIBA LIGHTING & TECHNOLOGY CORP., Tokyo (JP)

(21) Appl. No.: 10/329,414

(22) Filed: Dec. 27, 2002

(30) Foreign Application Priority Data
Dec. 28, 2001 (JP) 2001-399606
Aug. 27, 2002 (JP) 2002-246786

(51) Int. Cl. H05B 37/02

(52) U.S. Cl. 315/291; 315/224

(57) ABSTRACT

The invention provides a discharge lamp lighting apparatus. The apparatus comprises a first DC power supply circuit for converting an AC line voltage to a DC voltage, an inverter circuit provided with a switching element and a transformer, thereby the DC voltage supplied from the first DC power supply circuit is converted to a high frequency voltage for lighting a discharge lamp by an on-off switching operation of the switching element, an inverter controller for controlling the high frequency voltage output of the inverter by controlling the on-off switching operation of the switching element, a second DC power supply circuit for supplying a second DC voltage to the inverter controller through a power input end of the inverter controller, the second DC power supply circuit being provided with a detection winding inductively coupled to the transformer, thereby the second DC voltage being obtained by rectifying an induced current in the detection winding.

### 2. FIELD OF THE INVENTION

This invention relates to a discharge lamp lighting apparatus.

This application is based upon and claims the benefit of priority from the prior Japanese Patent Applications No. 2001-399606, filed Dec. 28, 2001 and No. 2002-246786, filed Aug. 27, 2002.

### 3. BACKGROUND OF THE INVENTION

In this type of discharge lamp lighting apparatus, conventionally a lamp voltage is detected for controlling a voltage to be fed to a discharge lamp. Moreover, when the detected lamp voltage is abnormal, a control for delighting a discharge lamp is carried out. Conventionally, with this type of discharge lamp lighting apparatus, the lamp voltage was detected directly.

Now, when parallel connection of two or more discharge lamps is made, with conventional apparatus, there is the necessity of providing a lamp voltage determiner for each discharge lamp of every. Therefore, in this case there is a problem of increasing the cost for manufacturing the discharge lamp lighting apparatus. On the other hand, when in-series connection of two or more discharge lamps is made, a lamp voltage determiner has the necessity of having high withstand voltage. In this case, expensive circuit elements are required. Therefore, in this case there is also a problem of increasing the cost for manufacturing the discharge lamp lighting apparatus.

Moreover, when the load circuit is isolated from the ground, there is a necessity of setting the potentials of individual terminals in the load circuit for earth potential. In this case, the circuit configuration becomes complicated by an increase of circuit elements. Therefore, in this case there is also a problem of increasing the cost for manufacturing the discharge lamp lighting apparatus.

A prior art, the Japanese patent application JP11-162680-A, discloses a discharge lamp lighting apparatus which comprises a detection winding electro-magnetically coupled to a resonance inductor for detecting voltage and a controller for controlling a switching element in an inverter circuit in accordance with the voltage detected by the detection winding for settling the voltage supplied to a fluorescence lamp in constant. Meanwhile, the above prior art comprises a dedicated circuit for detecting the lamp voltage. Therefore, this prior art has a problem of complicating the circuit configuration.

### 4. SUMMARY OF THE INVENTION

This invention has an object to provide a discharge lamp lighting apparatus which is able to control the lighting state of discharge lamps in a simple circuit construction.

In order to achieve the object, a first aspect of the discharge lamp lighting apparatus is characterized by comprising a first DC power supply circuit for converting an AC line voltage to a DC voltage, an inverter circuit provided with a switching element and a transformer, thereby the DC voltage supplied from the first DC power supply circuit is converted to a high frequency voltage for lighting a discharge lamp by an on-off switching operation of the switching element, an inverter controller for controlling the high frequency voltage output of the inverter by controlling the on-off switching operation of the switching element, a second DC power supply circuit for supplying a second DC voltage to the inverter controller through a power input end of the inverter controller, the second DC power supply circuit being provided with a detection winding inductively coupled to the transformer, thereby the second DC voltage being obtained by rectifying an induced current in the detection winding, and a monitor for monitoring a lighting state of the discharge lamp by checking the DC voltage supplied from the second DC power supply circuit.

According to the first aspect of the discharge lamp lighting apparatus, it is able to indirectly determine the lighting state of the discharge lamp according to the high frequency current, which is induced in the detection winding of the transformer and then supplied to the second DC power supply circuit. Therefore, the configuration of the discharge lamp lighting apparatus can be simplified, due to that there is no necessity of providing a specific lighting state monitor.

A second aspect of the discharge lamp lighting apparatus is characterized by that the monitor is provided with a lamp voltage determiner for determining a lamp voltage of the discharge lamp according to the DC supply voltage of the second DC power supply.

According to the second aspect of the invention, the lamp voltage determiner is able to indirectly determine the lamp voltage of the discharge lamp according to the DC supply voltage of the second DC power supply circuit. Therefore, there is no necessity of providing a lamp voltage determiner in the inverter circuit, and thus the discharge lamp lighting apparatus can be simplified.

A third aspect of the discharge lamp lighting apparatus is characterized by further comprising a starting circuit containing a starting resistor connected between the first DC supply circuit and the power input end of the inverter controller, thereby the starting circuit starting the inverter controller upon turning-on the discharge lamp lighting apparatus.

According to the third aspect of the invention, a starting operation for the discharge lamp upon turning-on the discharge lamp lighting apparatus can be securely carried out.

A fourth aspect of the discharge lamp lighting apparatus is characterized by further comprising a voltage limiter for limiting the second DC voltage.

With the third aspect of the discharge lamp lighting apparatus provided with the starting circuit for the inverter controller, when a lamp life terminal state, and an off-state of the discharge lamp are detected and the inverter controller is in the standby state, the voltage supplied from the starting circuit in an inverter controller rises suddenly, and there is a possibility that an inverter controller may be damaged. However, according to the fourth aspect of the discharge lamp lighting apparatus, the voltage supplied to an inverter controller is limited below the withstand voltage of the inverter controller.

A fifth aspect of the discharge lamp lighting apparatus is characterized by that the inverter controller is further provided with a reference voltage source, generating a reference voltage for defining the control operation of the inverter controller.

Therefore, according to the third aspect of the invention, the control operation of the inverter controller can be defined by the reference voltage.

A sixth aspect of the discharge lamp lighting apparatus is characterized by that the monitor comprises a detector for detecting a life terminal state or an off-state of the discharge lamp, and the reference voltage source comprises a first reference voltage source and a second reference voltage source.

Therefore, according to the sixth aspect of the invention, the control operation of the inverter controller can be defined by the reference voltage.

A seventh aspect of the discharge lamp lighting apparatus is characterized by that a safeguard for halting the inverter circuit when the detector detects the life terminal state or the off-state of the discharge lamp, wherein the first reference voltage source halts supplying a voltage when the inverter circuit halts, and the second reference voltage source keeps supplying a voltage to the safeguard during the halting of the inverter circuit.

According to the seventh aspect of the invention, in a standby state that the inverter circuit is deactivated, a power supply to a circuit, e.g., an oscillator, not required to be activated is halted, while a power supply to a circuit, e.g., the safeguard, required to be activated is halted for maintaining the standby state. Thus power consumption in the standby state of the inverter controller is depressed in a minimum amount.

A eighth aspect of the discharge lamp lighting apparatus is characterized by that the inverter controller is further provided with an integrating circuit containing a capacitor, a preheating period of the discharge lamp is defined by a time until the capacitor being charged to a first predetermined voltage, a starting period of the discharge lamp is defined by a time until the capacitor being further charged to a second predetermined voltage, a charged voltage of the capacitor is maintained between the first predetermined voltage and the second predetermined voltage when the discharge lamp lights normally and the inverter controller halts when the capacitor is charged to a voltage higher than the second predetermined voltage in case of the discharge lamp being in the lamp life terminal state or the off-state of the discharge lamp.

According to the eighth aspect of the invention, a timer for managing the preheating period, and a timer for managing the starting period so that an oscillation of the inverter controller may not immediately halt when the discharge lamp has come to a life terminal state or an off-state can be realized by a unitary integrating circuit. Therefore, a specific circuit for detecting a starting operation of the discharge lamp becomes unnecessary.

A ninth aspect of the discharge lamp lighting apparatus is characterized by that the inverter controller varies an output frequency so as to keep the DC voltage of the second DC power supply circuit constant during both periods of the preheating and the starting, and the inverter controller fixes the output frequency after the discharge lamp lights.

The ninth aspect of the discharge lamp lighting apparatus is characterized by that when the discharge lamp lights up after passing over the preheating period and the starting period, it is controlled by the sixth aspect of the discharge lamp lighting apparatus so that the output oscillation frequency of an inverter controller becomes fixed.

A tenth aspect of the discharge lamp lighting apparatus is characterized by comprising a first DC power supply circuit for converting an AC line voltage to a DC voltage, a boosting chopper type regulator provided with a series connection of an inductor and a rectifying diode, a chopper transistor connected in parallel with the first DC power supply circuit via the inductor and a smoothing capacitor connected in parallel with the chopper transistor via the rectifying diode, a boosting chopper type regulator provided with a series connection of an inductor and a rectifying diode, a chopper transistor connected in parallel with the first DC power supply circuit via the inductor and a smoothing capacitor connected in parallel with the chopper transistor via the rectifying diode, a load circuit provided with a series connection of a transformer, a current-limiting inductor and a DC cutoff capacitor, the series connection being connected in parallel with one of the switching elements of the inverter circuit, and feeding the high frequency voltage output from the half-bridge type inverter circuit to the discharge lamp through the transformer, an inverter controller for controlling the high frequency voltage output of the inverter by controlling the on-off switching operations of the switching elements, a second DC power supply circuit provided with a detection winding inductively coupled to the transformer, thereby an induced current in the detection winding being rectified and then supplied to the inverter controller and a detector for detecting an off-state of the discharge lamp by checking the voltage of the DC power supplied from the second DC power supply circuit.

According to the tenth aspect of the discharge lamp lighting apparatus, a favorable dimming can be carried out because the inverter circuit is configured in the half bridge type circuit configuration.

According to the tenth aspect of the discharge lamp lighting apparatus, a higher harmonic interference can be prevented by a low distortion feature and a high power factor feature of the boosting chopper regulator. According to the tenth aspect of the discharge lamp lighting apparatus, since the voltage of the second DC power supply circuit is secured from the detection winding of the transformer before the chopper operation switching element is started, a reliable operation of the second DC power supply circuit is guaranteed.

Additional objects and advantages according to the present invention will be apparent to persons skilled in the art from a study of the following description and the accompanying drawings, which are hereby incorporated in and constitute a part of this specification.

### 5. BRIEF DESCRIPTION OF THE DRAWINGS

A more complete appreciation according to the present invention and many of the attendant advantages thereof will be readily obtained as the same becomes better understood by reference to the following detailed description when considered in connection with the accompanying drawings, wherein:

FIG. 1 is a circuit diagram showing a first embodiment of the discharge lamp lighting apparatus according to the present invention;

FIG. 2 is a circuit diagram showing in detail the inverter controller in FIG. 1;

FIG. 3 is a circuit diagram showing in detail the reference voltage generator in FIG. 2;

FIG. 4 is graph showing the relation of the power supply voltage of a discharge lamp and the lamp voltage which are turned on with the discharge lamp lighting apparatus of FIG. 1;

FIG. 5 is the timing chart of each terminal voltage in the discharge lamp lighting apparatus of FIG. 1;

FIG. 6 is a circuit diagram showing the inverter controller in a second embodiment of the discharge lamp lighting apparatus according to the present invention;

FIG. 7 is a circuit diagram showing in detail the inverter controller in FIG. 6;

FIG. 8 is a circuit diagram showing a third embodiment of the discharge lamp lighting apparatus according to the present invention;

FIG. 9 is a circuit diagram showing a modification of the second DC power supply circuit of the discharge lamp lighting apparatus according to the present invention;

FIG. 10 is a circuit diagram showing other modifications of the second DC power supply circuit of the discharge lamp lighting apparatus according to the present invention; and

FIG. 11 is a circuit diagram showing a fourth embodiment of the discharge lamp lighting apparatus according to the present invention.

### 6. DESCRIPTION OF THE PREFERRED EMBODIMENTS

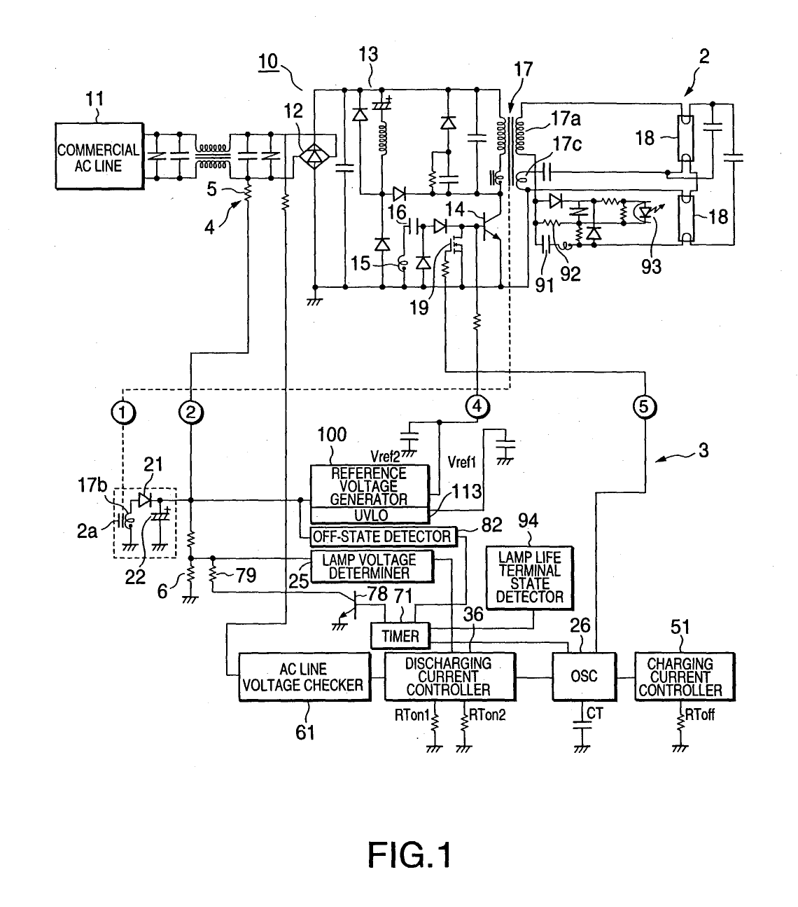

Referring now to FIGS. 1 to 11, some preferred embodiments of the discharge lamp lighting apparatus according to the present invention will be described.

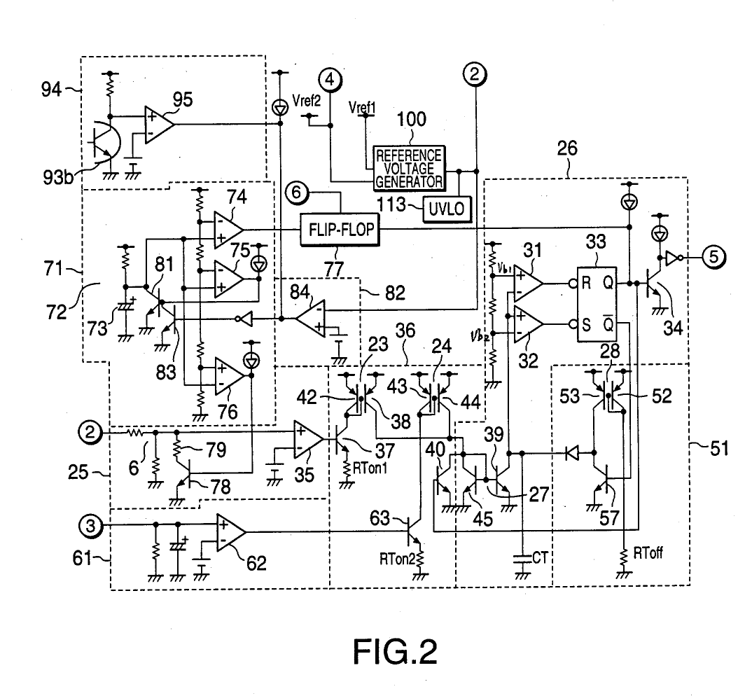

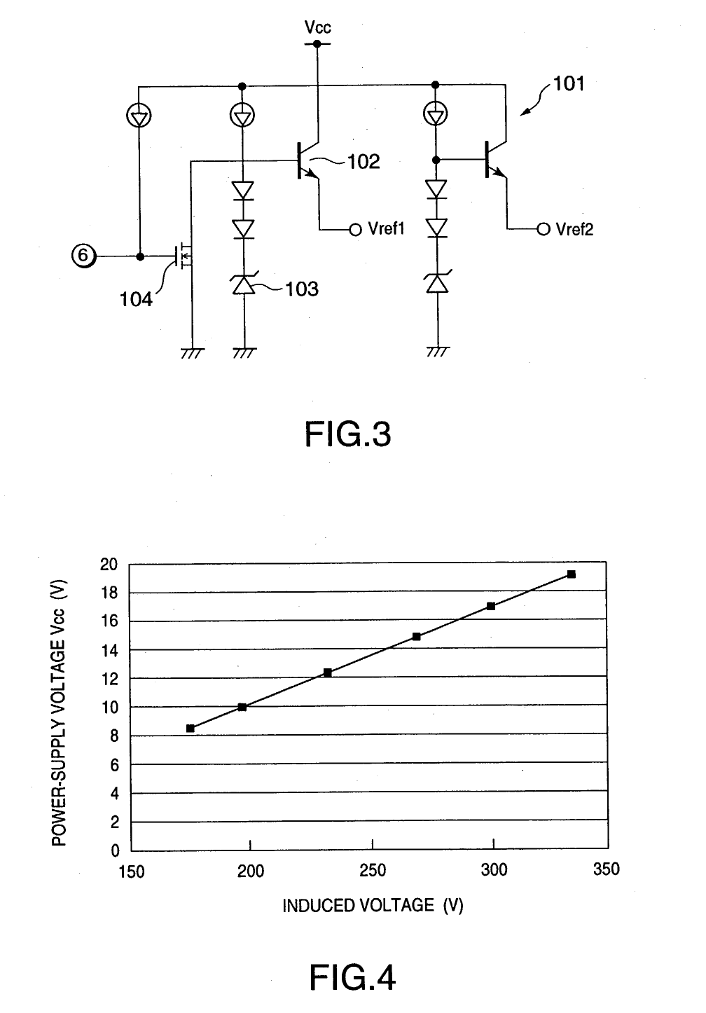

FIGS. 1 to 5 are drawings for explaining a first embodiment of the discharge lamp lighting apparatus according to the present invention. The discharge lamp lighting apparatus 1 in this first embodiment comprises an inverter circuit 2 and an inverter controller 3 for controlling the inverter circuit 2. The inverter circuit 2 is constituted in a voltage resonance type inverter circuit. FIGS. 2 and 3, respectively, illustrate the inverter controller 3 and the reference voltage generator 100 in FIG. 1, in more detail. Here, the symbols \mathring{1} to \mathring{6} in FIGS. 2 and 3 correspond to those in FIG. 1.

As shown in FIG. 1, the inverter circuit 2 has a first DC power supply circuit 10 which comprises a first rectifier 12 for rectifying the AC current from a commercial AC line 11 and a first smoother 13 for smoothing the current from the first rectifier 12. The inverter circuit 2 further comprises a piece of bipolar power transistor (switching element) 14. The bipolar power transistor 14 carries out a switching operation of turning on and turning off at a high frequency. Consequently, the output DC voltage of the first DC power supply circuit 10 is intermittent at a high frequency, thereby a high frequency current being derived from a transformer 17. The bipolar power transistor 14 is turned on in a manner of self-excitation by a base current supplied a current transformer 15, which is connected between its base terminal and a ground through a DC cut capacitor 16 and a diode. Moreover, an FET 19 is also connected between the base terminal of the bipolar power transistor 14 and the ground so that the bipolar power transistor 14 is controlled to be turned off when the FET 19 has turned on. The gate of the FET 19 is connected to an oscillator 26 in the inverter controller 3, as described in detail later. Therefore, the bipolar power transistor 14 turns on and off in switching operation in accordance with an oscillation frequency of the oscillator 26, and thus a high frequency current is derived from the transformer 17. The transformer 17 has a secondary winding 17a connected across a series connection of a plurality of discharge lamps, e.g., two pieces of discharge lamps 18, 18, as shown in FIG. 1. The discharge lamps 18, 18 are then lighted by the high frequency current supplied from the transformer 17.

The inverter controller 3 has a second DC power supply circuit 2a electro-magnetically coupled to a detection winding 17b of the transformer 17 in the inverter circuit 2. Therefore, a high frequency current induced in the detection winding 17b is supplied to the second DC power supply circuit 2a. This high frequency current is rectified in a second rectifier 21 of the second DC power supply circuit 2a, and then smoothed by a second smoother 22 in the second DC power supply circuit 2a. The inverter controller 3 may be constituted in an integrated circuit configuration. By the way, the power receiving end of the inverter controller 3 is also connected to the commercial AC line 11 of the inverter circuit 2 through a starting circuit 4. The starting circuit 4 has a starting resistor 5 with its one end connected to the commercial AC line 11 and its other end connected to the power receiving end of the inverter controller 3. Therefore, an AC line voltage is supplied to the inverter controller 3 through the starting circuit 4, i.e., the starting resistor 5 together with a DC voltage supplied from the second DC power supply circuit 2a.

The DC voltage from the second DC power supply circuit 2a is divided in a voltage divider 6. Consequently, a DC voltage reduced to a suitable level is supplied to a lamp voltage determiner 25 in the inverter controller 3. Therefore, a lamp voltage appearing in a load circuit of the inverter circuit 2 is indirectly determined by the lamp voltage determiner 25. In this manner, since information related to the lamp voltage is brought from the second DC power supply circuit 2a to the lamp voltage determiner 25, there is no necessity of providing a specific circuit for extracting a lamp voltage signal from the load circuit of the inverter circuit 2. That is, a voltage (see FIG. 4) proportional to the lamp voltage of the discharge lamp 18 is induced in the detection winding 17b of the transformer 17. The induced voltage is then brought into the inverter controller 3 through the second DC power supply circuit 2a. Therefore, the lamp voltage determiner 25 can indirectly detect the lamp voltage of the discharge lamp 18 through the induced voltage.

Therefore, when the two discharge lamps 18, 18 are connected in series, as shown in FIG. 1, and thus even when a totally high level voltage appears in the load circuit of the inverter circuit, the lamp voltage determiner 25 can detect the lamp voltage even if it has a low withstand voltage property. Moreover, even if the discharge lamp 18 is not connected to the ground, as shown in FIG. 1, the lamp voltage can be detected reliably.

The inverter circuit 2 is controlled by the inverter controller 3 by using the lamp voltage detected in the lamp voltage determiner 25. Now, the control of the inverter circuit 2 carried out by the inverter controller 3 will be described.

The inverter controller 3 comprises the oscillator 26, as described above. A high frequency oscillation signal generated by the oscillator 26 is supplied to the FET 19 of the inverter circuit 2. The FET 19 is turned on when the high frequency oscillation signal is in H level, while it is turned off when the oscillation signal is in L level. H level periods and the L level periods of the high frequency oscillation signal generated by the oscillator 26 vary in accordance with the lamp voltage detected in the lamp voltage determiner 25.

As shown in FIG. 2, the oscillator 26 is comprised of first and second comparators 31 and 32. Reference potentials Vb1 and Vb2 (Vb1>Vb2) with predetermined levels are applied to the non-inverted input terminal of the first comparator 31, and the inverted input terminal of the second comparator 32, respectively. Moreover, a charged voltage on a timing capacitor CT is supplied to the inverted input terminal of the first comparator 31, and the non-inverted input terminal of the second comparator 32, respectively. The output terminals of the first comparator 31 and the second comparator 32 are connected to an R input terminal and an S input terminal of an RS flip-flop 33, respectively. A Q output terminal of the RS flip-flop 33 is connected to the base terminal of a bipolar transistor 34 which constitutes a driver for driving the FET 19 of the inverter circuit 2. That is, the FET 19 is turned off and on by the on-off operation of the bipolar transistor 34. The Q output of the RS flip-flop 33 changes between the H-level and the L-level in accordance with the output levels of the first and second comparators 31 and 32 applied to the R input terminal and S input terminal of the RS flip-flop 33. Therefore, the Q output level is defined by the voltage of the timing capacitor CT. The charged voltage of the timing capacitor CT varies in accordance with the charging current to the timing capacitor CT, and the discharging current from the timing capacitor CT. Therefore, the ON duration and the OFF duration of the bipolar transistor 34 are varied according to a voltage change of the timing capacitor CT.

The discharging current from the timing capacitor CT is defined by a discharging current controller 36. The discharging current controller 36 is provided with two current mirrors, i.e., a first current mirror 23 and a second current mirror 24. One transistor 42 of the first current mirror 23 is connected in series with a transistor 37 and a resistor Rton1. Thus the current flowing in the transistor 42 is defined by the emitter voltage of the transistor 37 and the resistance of the resistor Rton1. A current the same with the current of the transistor 42 also flows in the other transistor 38 of the first current mirror 23. The current flowing in the transistor 38 is then supplied to the oscillator 26. Similarly, one transistor 43 of the second current mirror 24 is connected in series with a transistor 63 and a resistor Rton2. Thus the current flowing in the transistor 43 is defined by the emitter voltage of the transistor 63 and the resistance of the resistor Rton2. A current the same with the current of the transistor 43 also flows in the other transistor 44 of the second current mirror 24. The current flowing in the transistor 44 is then supplied to the oscillator 26. That is, a total amount of the collector current of the transistor 38 and the collector current of the transistor 44 is supplied to the oscillator 26. While the total amount of the currents flows into a third current mirror 27 provided on the input end of the oscillator 26 as a collector current of one transistor 45 which constituting the third current mirror 27. Therefore, a current the same with the current of the transistor 45 also flows in the other transistor 39 of the third current mirror 27. The collector current of the transistor 39 flows out from the timing capacitor CT as its discharging current. Therefore, the discharging current from the timing capacitor CT is defined by the resistances of the resistors RTon1 and RTon2.

In addition, a transistor 40 is connected in parallel with the third current mirror 27, while its base terminal is connected to the Q output terminal of the RS flip-flop 33. Therefore, the transistor 40 is turned on when the Q output terminal of the RS flip-flop 33 is in H level. When the transistor 40 is turned on, the current which flows in the third current mirror 27 will decrease, and the discharge of the timing capacitor CT will be suppressed. In addition, when the timing capacitor CT is charged, the Q output terminal of the RS flip-flop 33 becomes H level, as described later. Therefore, when it does in this way and the timing capacitor CT is charged, the transistor 40 is turned on and the discharge from the timing capacitor CT is suppressed.

The charging current to the timing capacitor CT is defined by a charging current controller 51. The charging current controller 51 has a fourth current mirror 28. One transistor 52 of the fourth current mirror 28 is connected in series with a resistor Rtoff. Thus the current flowing in the transistor 52 is defined by the resistance of the resistor Rtoff. A current the same with the current of the transistor 52 also flows in the other transistor 53 of the fourth current mirror 28. The current flowing in the transistor 53 is then supplied to the oscillator 26. That is, the collector current of the transistor 53 flows the timing capacitor CT as a charging current. Therefore, the charging current of the timing capacitor CT is defined by the resistance of the resistor RToff.

In addition, a transistor 57 is connected in series with the transistor 53 of the fourth current mirror 28, while its base terminal is connected to a Qinv output terminal (here, Qinv output represents an inverted output opposite to the Q output) of the RS flip-flop 33. The transistor 57 is turned on when the Qinv output terminal is in H level. When the timing capacitor CT is discharged, the Qinv output terminal of the RS flip-flop 33 becomes H level, as described later. Therefore, when it does in this way and the timing capacitor CT discharges, the transistor 57 is turned on and the charge to the timing capacitor CT is suppressed.

The lamp voltage determiner 25 is connected to the discharging current controller 36 through an operational amplifier 35. That is, the operational amplifier 35 is connected to the base terminal of the transistor 37 which is connected in series with a resistor RTon1. Therefore, when the lamp voltage detected in the lamp voltage determiner 25 rises, the emitter voltage of the transistor 37 of the discharging current controller 36 will rise, and the current which flows in the first current mirror 23 will increase. Whereby, the discharging current from the timing capacitor CT increases, and the OFF duration of the FET 19 becomes short, therefore the ON duration of the bipolar power transistor 14 becomes short. Herewith, the ON-OFF switching cycle of the inverter circuit 2 becomes short, and the inverter output supplied to the discharge lamp 18 connected to the transformer 17 decreases. Whereby, the high frequency current induced in the detection winding 17b of the transformer 17 decreases.

The decrease of the high frequency current is detected as a drop of the lamp voltage in the lamp voltage determiner 25. Whereby, the charging current to the timing capacitor CT decreases, and the OFF duration of the FET 19 becomes long. Therefore the ON duration of the bipolar power transistor 14 becomes long. Herewith, the ON-OFF switching cycle of the inverter circuit 2 becomes long, and thus the inverter output supplied from the transformer 17 to the discharge lamp 18 increases. In this manner, a feedback control is carried out so that the lamp voltage is kept in almost constant by the inverter controller 3.

The inverter controller 3 is further provided with an AC line voltage checker 61 is included further in the. The AC line voltage checker 61 is connected to the discharging current controller 36 through an operational amplifier 62, as shown in FIG. 2. That is, the operational amplifier 62 is connected to the base terminal of a transistor 63 which is connected in series with a resistor RTon2. Therefore, when the voltage of the commercial AC line 11 detected in the AC line voltage checker 61 drops, the current flowing in the second current mirror 24 decreases. Whereby, the discharging current from the timing capacitor CT decreases, and the OFF duration of the FET 19 becomes long. Therefore the ON duration of the bipolar power transistor 14 becomes long. Herewith, the ON-OFF switching cycle of the inverter circuit 2 becomes long, and the inverter output supplied to the discharge lamp 18 connected to the transformer 17 increases it. On the other hand, when the voltage of the commercial AC line 11 rises, the inverter output supplied to the discharge lamp 18 decreases. Therefore, when the voltage of the commercial AC line 11 varies during lighting of the discharge lamp 18, feed-forward control for suppressing the change of the inverter output supplied to the discharge lamp 18 by the AC line voltage checker 61 is carried out.

Now, the reason why two resistors RTon1 and RTon2 for setting discharging current are provided in the discharging current controller 36 will be described. Generally the discharge lamp 18 is turned on after passing over a preheating period (about one second) and a starting period. In the starting period, the lamp voltage raises higher than the voltage in lighting state. Therefore, the output signal voltage of the lamp voltage determiner 25 becomes high. Whereby, the current flowing in the resistor RTon1 increases and the discharging current from the timing capacitor CT flows also in the resistor RTon1. When the discharge lamp 18 lights up, since the lamp voltage of the discharge lamp 18 will drop, the output signal of the lamp voltage determiner 25 becomes a low level. Whereby, the current flowing in the resistor RTon1 is almost eliminated, and the most of the discharging current from the timing capacitor CT flows in the resistor RTon2. Therefore, in lighting state the discharging current from the timing capacitor CT is defined by only the resistor RTon2. In this manner, in the starting period, the discharging current from the timing capacitor CT is defined by both resistors RTon1 and RTon2, and in lighting state it is defined by only the resistor RTon2. Therefore, the inverter controller 3 can transfer to the operation required for lighting the discharge lamp 18 from the operation required for starting the discharge lamp 18 automatically, without a specific circuit for detecting the transfer from the starting period to the lighting state.

Therefore, when the operation changes from the starting period in which the lamp voltage is kept constant in a higher level to the lighting state, the inverter output supplied to the discharge lamp 18 decreases so that the oscillation frequency of the oscillator 26 also lowers. Then, even if the inverter output (lamp voltage) tends to excessively rise, the oscillation frequency of the oscillator 26 is controlled to become constant. Therefor, the inverter controller 3 is prevented from being damaged.

Now, a timer 71 for setting the preheating period, the starting period, and the turning point to the lighting state of the discharge lamp 18 will be described. The timer 71 has an integrating circuit 72. A first reference voltage Vref1, which will be described later, is supplied to a capacitor 73 constituting the integrating circuit 72, and thus the capacitor 73 is charged. The charged voltage of the capacitor 73 is supplied to the inverted input end of a third comparator 74 established in the timer 71, respectively, the inverted input end of a fourth comparator 75, and the inverted input end of a fifth comparator 76, respectively. On the other hand, the predetermined reference potentials Vb3, Vb4, and Vb5 (Vb3>Vb4>Vb5) is applied to the inverted input end of the third comparator 74, the inverted input end of the fourth comparator 75, and the inverted input end of the fifth comparator 76, respectively.

In a state that the voltage of the capacitor 73 is adequately low, the fifth comparator 76 applies an L level signal to the base terminal of a bipolar transistor 78. When the voltage of the capacitor 73 exceeds the fifth reference potential Vb5, the fifth comparator 76 operates and a bipolar transistor 78 is turned on. The bipolar transistor 78 is connected to the input end of the operational amplifier 35 of the lamp voltage determiner 25 in series connection with the resistor 79. Therefore, even if the lamp voltage of the discharge lamp 18 is constant, the detection output of the lamp voltage determiner 25 varies. Therefore, by the inverter controller 3, the output of the inverter circuit 2 increases and the voltage supplied to the discharge lamp 18 rises to a level required for starting.

Then, when the voltage of the capacitor 73 exceeds the fourth reference potential Vb4 after passing over a predetermined time further, the output of the fourth comparator 75 becomes H level. Whereby, a bipolar transistor 81 connected in parallel with the capacitor 73 turns on, and thus the capacitor 73 discharges. The voltage of the capacitor 73 drops below the fourth reference voltage Vb in accompanying the discharging of the capacitor 73. Therefore, the output of the fourth comparator 75 becomes L level, a bipolar transistor 81 is turned off, and the capacitor 73 is charged. In this manner, charge and the discharge of the capacitor 73 are repeated by turns, and the voltage of the capacitor 73 is maintained around the fourth reference potential Vb4.

In addition, even if an adequately high starting voltage is supplied, when the discharge lamp 18 does not light up, an off-state of the discharge lamp is detected by an off-state detector 82. The off-state detector 82 has a sixth comparator 84 connected to the second DC power supply circuit 2a. In the state of such un-switching on the light, it is held as the output voltage of the inverter circuit 2 is high, and the high voltage which is correspondingly induced in the detection winding 17b is supplied to the sixth comparator 84. Therefore, the output end becomes H level, the transistor 83 connected to the base terminal of the transistor 81 of the timer 71 is turned on, and a bipolar transistor 81 is turned off. Whereby, the capacitor 73 of the integrating circuit 72 is charged and the voltage exceeds the third reference potential Vb3. Therefore, the output of the third comparator 74 becomes H level, and it is latched to the flip-flop 77 connected between the third comparator 74 and the base terminal of the transistor 34 of the oscillator 26. Consequently, the transistor 34 is turned on and the drive of the discharge lamp 18 is halted.

Now, life terminal state detection of the discharge lamp 18 will be described. As shown in FIG. 1, the inverter circuit 2 has a photo-coupler 93 further. The photo-coupler 93 is connected to the secondary winding 17a of the transformer 17 with the circuit element relevant to it especially a capacitor 91, and a resistor 92. When the discharge lamp 18 is in the state of a life terminal state, the peak values of the positive and negative half-cycles of the AC lamp current become unbalanced, and thus a DC component occurs in the lamp current. The DC component fails to flow in a capacitor 91, but flows in the resistor 92. When the DC component becomes large, the voltage across the resistor 92 will rise. The voltage across the resistor 92 is supplied to a photo-coupler 93, and that light emitting diode 93a emits light. A phototransistor 93b of the photo-coupler 93 is provided in the input circuit of a lamp life terminal state detector 94, as shown in FIG. 2. The lamp life terminal state detector 94 has a seventh comparator 95 connected to a phototransistor 93b, and the output end is connected to the base terminal of the transistor 83 with the output end of the sixth comparator 84 of the off-state detector 82. Therefore, the phototransistor 93b by which optical connection is made with light emitting diode 93a is turned on. Consequently, the output end of the seventh comparator 95 of the lamp life terminal detector 94 becomes H level, has the transistor 83 turned on, and turns off a bipolar transistor 81. Whereby, the discharge lamp 18 is turned off in the manner as with the operations in the off-state detector 82. That is, the capacitor 73 of the timer 71 is charged by turning off a bipolar transistor 81. When the voltage exceeds the third reference potential Vb3, the output of the third comparator 74 becomes H level, and it is latched to the flip-flop 77 connected between the third comparator 74 and the base terminal of the transistor 34 of the oscillator 26. Consequently, the transistor 34 is turned on and the drive of the discharge lamp 18 is halted. In this manner, also when the life terminal state of the discharge lamp 18 is detected in the lamp life terminal detector 94, the discharge lamp 18 fails to be turned off immediately, but a lighting state is maintained for a while by the timer 71. According to the above configuration, it is prevented that a temporal unbalanced state of the positive and negative half cycle discharges would be detected in mulfunction as the discharges in the lamp life terminal state.

In this manner, the fifth comparator 76 for setting the preheating period, the third comparator 74 for setting the starting period, and the fourth comparator 75 which holds the lighting state of the discharge lamp 18 for a while come out, and the unitary integrating circuit 72 is shared and it comprises timers 71. Moreover, since the capacitor 73 of the integrating circuit 72 is further used to prevent the malfunction of the off-state detector 82 or the lamp life terminal state detector 94, the circuit configuration can be simplified.

By the way, the inverter controller 3 in this embodiment has the reference voltage generator 100 further. The reference voltage generator 100 is able to generate two types of reference voltages, i.e., a first reference voltage Vref1 and a second reference voltage Vref2 The first reference voltage Vref1 is output or halted according to a power-supply voltage Vcc supplied to the inverter controller 3. On the other hand, the second reference voltage Vref2 is always output Referring now to FIG. 3, the reference voltage generator 100 will be described in detail. The reference voltage generator 100 has two transistors 101,102, and their collectors are connected to the common power supply line 105 to which the power-supply voltage Vcc of the inverter controller 3 is supplied. A fixed reference voltage is supplied to the base terminal of the transistor 101 of one of these by a first base bias source which comprises the diode of a number suitably with the Zener diode 106, and in-series connection is made between the common power supply line 105 and the ground. Consequently, the second reference voltage Vref2 arises on the emitter terminal of a transistor 101. The base terminal of the other transistor 102 is connected to a second base bias source which comprises a series connection of a Zenor diode 106 and a suitable number of diodes, and is connected between the common power supply line 105 and the ground, and then connected to the flip-flop 77 through an FET 104. Consequently, the first reference voltage Vref2 arising on the emitter terminal of a transistor 102 is controlled by the flip-flop 77. When it follows, for example, the life terminal state of the discharge lamp 18 is detected in the lamp life terminal state detector 94, the FET 104 turns on with the output signal of the flip-flop 77, and a transistor 102 is turned off. Consequently, the first reference voltage Vref1 is halted.

Now, the reason why two reference voltages are provided and used properly will be described. First, the power-supply voltage Vcc is supplied through the starting circuit 4 immediately at a turning-on of the discharge lamp lighting apparatus itself from the commercial AC line 11. At this time, the first and the second reference voltages Vref1, Vref2 are concurrently derived from the reference voltage generator 100, and the entirety of the inverter controller 3 is activated. After starting of the inverter controller 3, the oscillation output derived from the oscillator 26 in the inverter controller 3 is applied immediately in the inverter circuit 2, and the conversion from the DC current to the high frequency AC current in the inverter circuit 2 is started. The power-supply voltage Vcc based on the high frequency current induced in the detection winding 17b of the transformer 17 is supplied to the inverter controller 3 upon starting the conversion from the DC current to the high frequency AC current in the inverter circuit 2. Henceforth, the inverter controller 3 operates with the power-supply voltage Vcc from the second DC power supply circuit 2a. In this manner, when the power-supply voltage Vcc comes to be obtained from the second DC power supply circuit 2a, since the power supply from the starting circuit 4 will become unnecessary, the starting current supplied via the starting circuit 4 is designed so that it may become necessary minimum.

Under these conditions, if an off-state of the discharge lamp is detected in the off-state detector 82 or the life terminal phenomenon (namely, in one direction flowed generating accompanying the state in positive and negative half cycle discharges of the discharge lamp 18 where it does not balance) of a discharge lamp is detected in the lamp life terminal state detector 94, the safeguard which a transistor 83 turns on as a safeguard will work. Consequently, the oscillator 26 of the inverter controller 3 is halted, and the inverter circuit 2 will become a standby state. In such the standby state, the inverter controller 3 operates in the state of low power consumption under the power supply via the starting circuit 4. And when the power supply voltage is reset or it is exchanged for a new discharge lamp, the inverter circuit 2 and the inverter controller 3 return to the original state of operation immediately.

Any current is not induced in the detection winding 17b of the transformer 17 during the standby state wherein the conversion from the DC current to the high frequency AC current in the inverter circuit 2 is halted. Therefore, only the starting current supplied from the starting circuit 4 is applied to the inverter controller 3 in this period. However, since this starting current is supplied through the starting resistor 5, a loss is induced in the starting resistor 5. Starting current must be lessened for making this loss as small as possible. Therefore, in the standby state it is desirable to supply reference voltages only to circuit elements required for maintaining the inverter circuit 2 in the standby state, while halting the supply of the reference voltage to the other circuit elements.

So, in this embodiment, two kinds of reference voltages are provided and then one of the reference voltages for circuit elements, such as the oscillator 26, not required to maintain its operation is halted during the standby state. On the other hand, it is made to always supply the reference voltage to circuit elements (e.g., transistors 83, 34, a lamp installation detector, etc.) required for maintaining their operations during the standby state.

When the power-supply voltage Vcc supplied from the second DC power supply circuit 2a becomes extremely low, whole or a part of the inverter controller 3 fails to normally operate. In order to prevent such problem, a low-voltage malfunction prevention circuit or an under-voltage lockout circuit (hereinafter referred to as UVLO) 113 is attached to the reference voltage generator 100. When the power-supply voltage Vcc supplied from the second DC power supply circuit 2a becomes extremely low and the inverter controller 3 fails to normally operate, the UVLO 113 halts the oscillation of the oscillator 26, and prevents the malfunction of the inverter controller 3.

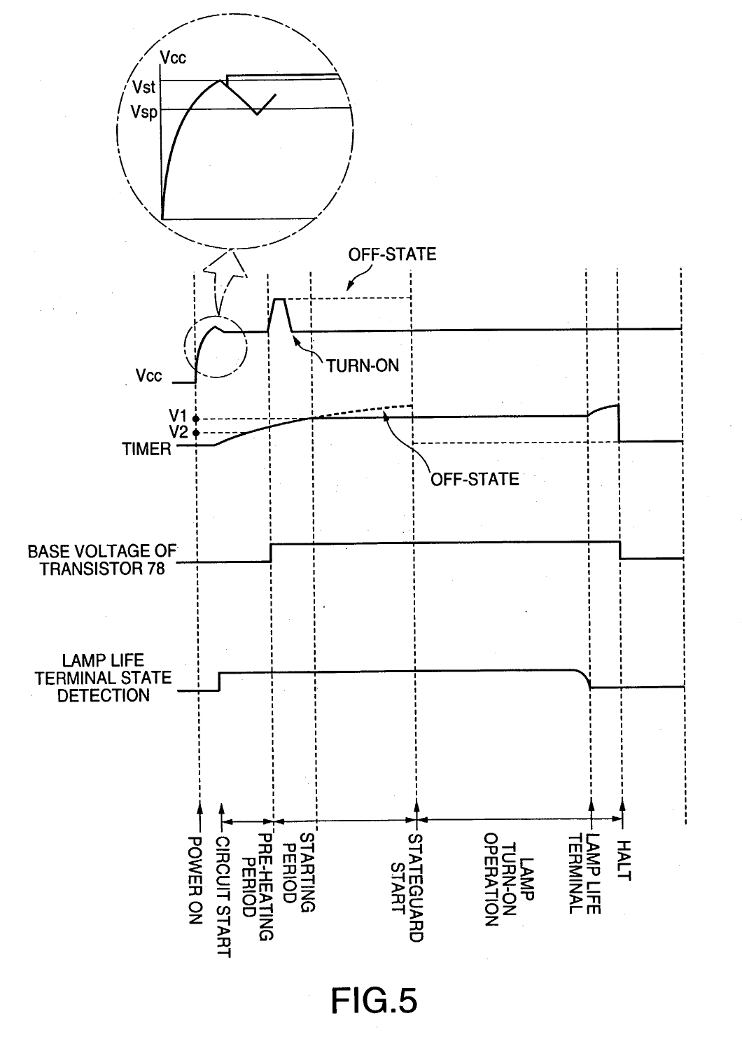

Referring now to FIG. 5, the operation of this embodiment will be described. Especially a circle in the drawing illustrates the change of the power-supply voltage Vcc at the time of starting the discharge lamp in detail. For example, the halting voltage level Vsp and the starting voltage level Vst are set to the UVLO 113 as a comparison standard level which detects the power-supply voltage Vcc. The power-supply voltage Vcc is supplied from the starting circuit 4 in the starting period at a turning-on of the discharge lamp lighting apparatus itself. When the power-supply voltage Vcc rises to the starting voltage level Vst, the inverter controller 3 will be started. Whereby, two reference voltages Vref1 and Vref2 are generated in the reference voltage generator 100. The oscillator 26 operates under the reference voltage Vref1. Whereby, the oscillation signal is supplied to the inverter circuit 2, and the inverter controller 3 is started. That is, the conversion from the DC current to the high frequency AC current is started in the inverter circuit 2. High frequency current is induced according to the above operation of the inverter circuit 2 at the detection winding 17b of the transformer 17. The power-supply voltage Vcc obtained by rectifying the high frequency current in the second DC power supply circuit 2a is supplied to the inverter controller 3. When the power-supply voltage Vcc is maintained at a level above the starting voltage level Vst, the inverter controller 3 will continue the regular control operation.

On the other hand, the power-supply voltage Vcc to the inverter controller 3 drops below the halting voltage level Vsp since an adequate amount of the induced current can not be obtained, when the discharge lamp 18 fails to be lighted, even if the inverter circuit 2 starts the conversion from the DC current to the high frequency AC current at the time of starting. In this case, the UVLO 113 operates to halt the oscillation of the oscillator 26. Therefore, the operation of the inverter circuit 2 is halted and thus the power supply voltage to the inverter controller 3 from the second DC power supply circuit 2a is halted.

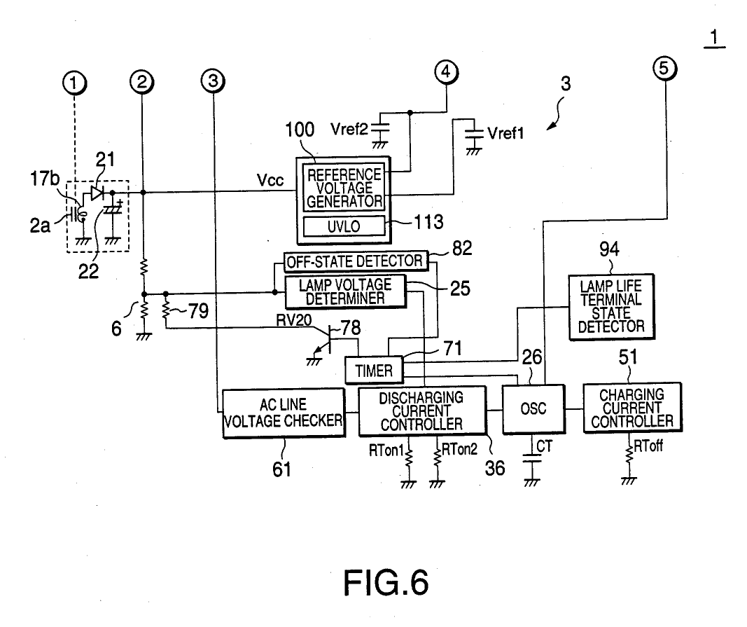

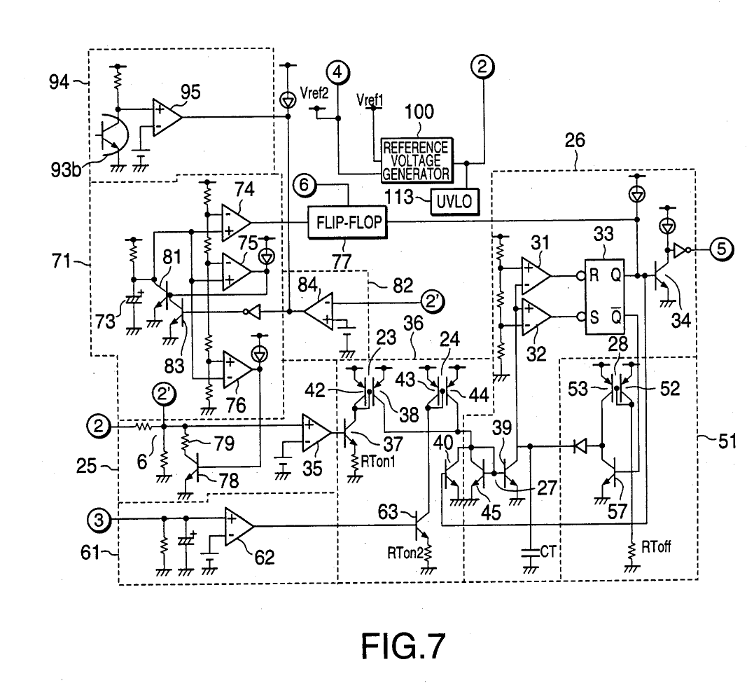

Referring now to FIGS. 6 and 7, a second embodiment of the discharge lamp lighting apparatus according to the present invention will be described. FIGS. 6 and 7, respectively, illustrate an abridged configuration and a detailed configuration of the inverter controller 3. In FIGS. 6 and 7, the same or identical elements with those in FIGS. 1 and 2 are assigned with same reference numerals omitted their explanation.

The second embodiment has a principal construction the same as the first embodiment. The second embodiment is different from the first embodiment in that the off-state detector 82 is connected to the voltage divider 6 as well as the lamp voltage determiner 25.

According to the second embodiment, a circuit for generating the reference voltages and a circuit for detecting the lamp voltage and the off-state of discharge lamps can be separately connected to the second DC power supply circuit 2a. Therefore, a processing of the power-supply voltage Vcc obtained by the second DC power supply circuit 2a becomes easy.

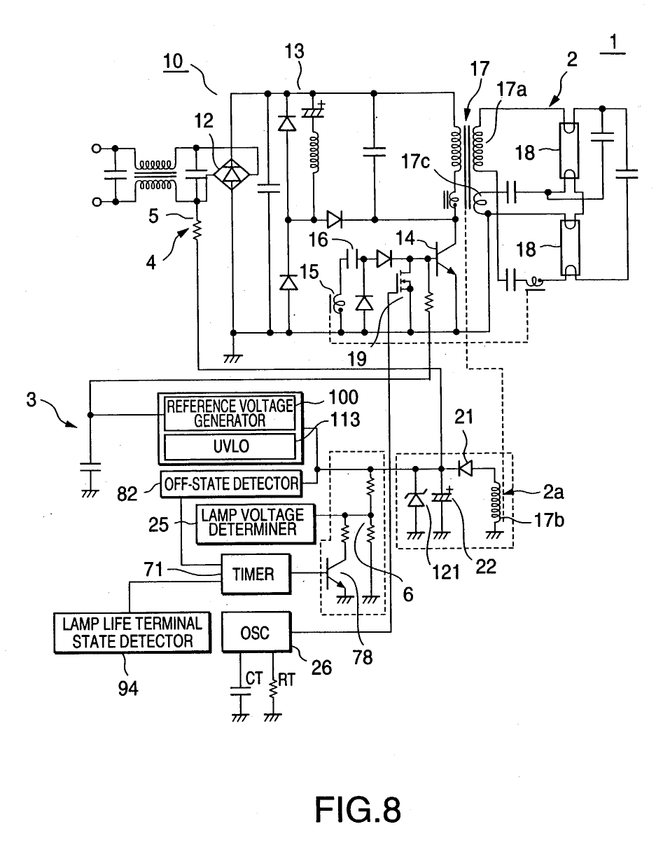

Referring now to FIG. 8, a third embodiment of the discharge lamp lighting apparatus according to the present invention will be described. In FIG. 8, the same or identical elements with those in FIG. 1 are assigned with same reference numerals omitted their explanation.

A Zener diode 121 is connected to the output end of the second DC power supply circuit 2a for limiting an excessive voltage from being output. The Zener voltage of the Zener diode 121 is set a value below the withstand voltage of the inverter controller 3.

Also in the third embodiment, the inverter controller 3, the starting circuit 4, and the second DC power supply circuit 2a, etc., have the same configuration and the same feature as those of the first and the second embodiments. For example, when an off-state of the discharge lamp is detected in the off-state detector 82 or the lamp life terminal state, i.e., a state of appearing a DC component caused by an unbalance between the positive and negative half-cycle discharges in the discharge lamp 18 in the lamp life terminal state detector 94, the safeguard for turning on the transistor 83 is activated. Consequently, the oscillator 26 of the inverter controller 3 is halted, and the inverter circuit 2 will become the standby state. In such a standby state, the inverter controller 3 operates in the state of low power consumption under the power supply from the starting circuit 4. And when the power supply voltage is reset or the discharge lamp 18 is changed to a new one, the power-supply voltage Vcc supplied to the inverter controller 3 in the standby state to which the inverter circuit 2 and the inverter controller 3 return to the original state of operation immediately becomes a divided value by the resistance of the starting resistor 5, and the impedance of the inverter controller 3 about commercial exchange voltage. In addition, although the starting period upon turning-on the discharge lamp lighting apparatus will be shortened, when the resistance of the starting resistor 5 is lowered and the power supply voltage to the inverter controller 3 during the starting period is raised, the power consumption in the standby state of the inverter controller 3. Therefore, the values must be chosen as a moderate value.

In the third embodiment, since the Zener diode 121 is provided in the power supply circuit of the inverter controller 3, the power-supply voltage Vcc supplied to the inverter controller 3 is limited up to the Zener voltage of the Zener diode 121. Therefore, even if an excessive voltage is induced in the detection winding 17b of the transformer 17, the inverter controller 3 is protected from being supplied the excessive voltage. In addition, the current flowing in the Zener diode 121 is suppressed by the starting resistor 5. Therefore, a Zener diode with a relatively low rate of power withhold characteristic can be used as the Zener diode 121.

Therefore, according to the third embodiment, the power-supply voltage Vcc supplied to the inverter controller 3 can be limited below the withstand voltage of the inverter controller 3.

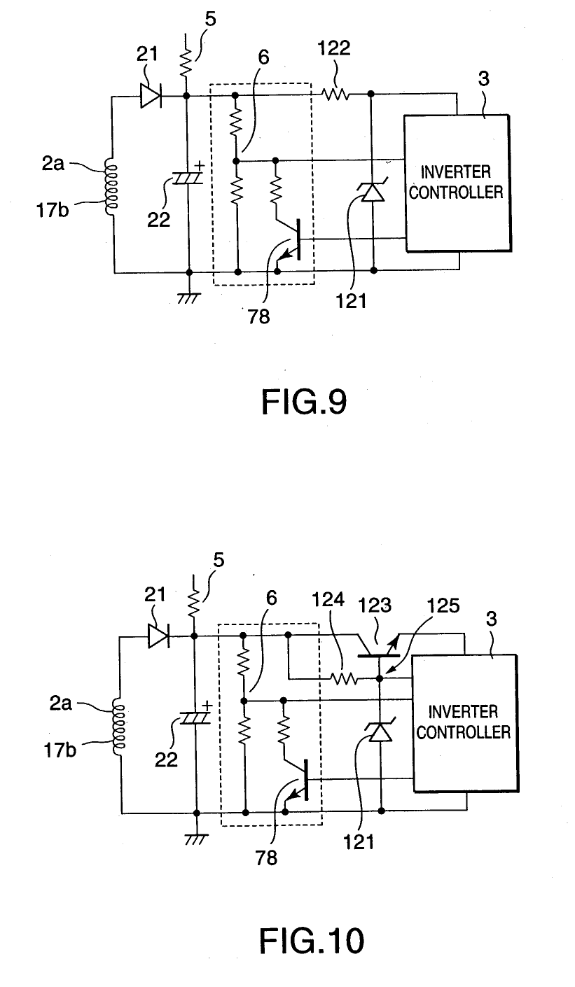

By the way, the power-supply voltage Vcc supplied to the inverter controller 3 is proportional to the lamp voltage in the inverter circuit 2, as described above. The lamp voltage in the starting period becomes extremely higher than that in a normal lighting state. Therefore, there is a possibility that the voltage supplied to the power supply circuit to the inverter controller 3 during the starting may exceed the withstand voltage of the inverter controller 3. Therefore, it is needed to limit the voltage supplied to the Zener diode 121. However, the resistance of the starting resistor 5 cannot be made higher from the above reason. Alternatively, another configuration in which a resistor 122 is inserted between the second DC power supply circuit 2a and the Zener diode 121 can be employed, as shown in FIG. 9,

Referring now to FIG. 10, another configuration of the power supply circuit to the inverter controller 3 will be described. In this example of the power supply input circuit, the voltage regulator 125 is inserted between the second DC power supply circuit 2a and the inverter controller 3. The voltage regulator 125 comprises a transistor 123 with its collector-to-emitter passage inserted in the power supply line of the second DC power supply circuit 2a, the Zener diode 121 connected between the base of the transistor 123 and the ground, and a resistor 124 connected across the collector and the base of the transistor 123. Here, the transistor 123 is set up so that the collector voltage (input voltage) becomes higher than the emitter voltage (output voltage).

Since such a voltage regulator 125 is well known, a detailed explanation for the operation of the voltage regulator 125 will be omitted. By providing such a voltage regulator 125, the power-supply voltage Vcc supplied to the inverter controller 3 is limited below the withstand voltage of the inverter controller 3. In this example of the power supply circuit, as shown in FIG. 10, the same voltage limiting feature as the power supply circuit, as shown in FIG. 9 is achieved. However, since an electric power loss arises in the resistor 122 in the power supply circuit, as shown in FIG. 9, the power supply circuit, as shown in FIG. 10, is superior to the power supply circuit, as shown in FIG. 9.

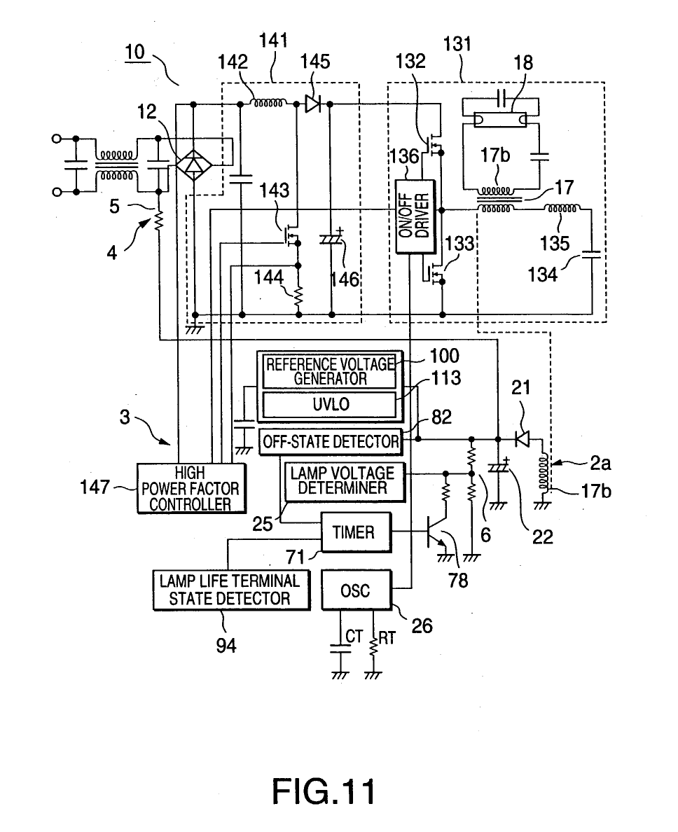

Referring now to FIG. 11, a fourth embodiment of the discharge lamp lighting apparatus according to the present invention will be described. In FIG. 11, the same or identical elements with those in FIG. 1 are assigned with same reference numerals omitted their explanation. Although a voltage resonance type single transistor inverter circuit is used for the inverter circuit 2 in the first or the third embodiment, a half bridge type inverter circuit 131 is used in the fourth embodiment.

In FIG. 11, the half bridge type inverter circuit 131 has a pair of power MOSFETs (switching elements) 132, 133 which are connected in-series so as to complementarily turns on and off at a high frequency. The primary winding, the current-limiting inductor 135, and the DC cut capacitor 134 of the transformer 17 are connected in series between the connecting nodes and grounding points. The gates of the power MOSFETs 132 and 133 are connected to a driver 136 for driving the power MOSFETs 132 and 133 to complementrarily turn on or off upon receiving the oscillation output of the oscillator 26. The discharge lamp 18 is connected to the secondary winding 17a of the transformer 17. Here, the transformer 17 has a detection winding 17b which constitutes the second DC power supply circuit 2a, in similar to the first to third embodiments, as described above.

Furthermore, between the inverter circuit 131 and its power supply circuit (first DC power supply circuit 10), a boosting chopper voltage regulator 141 with a low distortion and high efficiency characteristics is inserted as a countermeasure for answering a harmonics regulation. The voltage regulator 141 comprises a chopper control inductor 142 connected to the output line of the first rectifier 12, a power MOSFET (chopper operation switching element) 143, a resistor 144 connected in series with the power MOSFET 143, a fectifying diode 145, and a smoothing capacitor 146 connected across the output terminals of the regulator 141.

Moreover, the inverter controller 3 is provided a high power factor controller 147 for controlling the switching operation of the inverter 141 according to the charged voltage of the smoothing capacitor 146 and the voltage across the resistor 144.

Since the boosting chopper voltage regulator 141 is well known, a detailed explanation of their operation will be omitted. In the voltage regulator 141, the full wave rectification voltage is carried out an ON-OFF switching at a high frequency by the power MOSFET 143 by using the charged voltage of the smoothing capacitor 145, the voltage across resistor 144, etc. Here, an input voltage waveform is corrected in macroscopic to a line voltage waveform similar to the line voltage waveform under a favor of that the input voltage waveform comes to have the average value of every cycle of the high frequency switching current.

Here, since the half bridge type inverter circuit 131 is well known, a detailed explanation of their operation will be omitted. Since the half bridge type inverter circuit 131 comprises a pair of power MOSFETs 132, 133, a lighting control becomes possible and a light dimming becomes easy by varying the on/off ratio (i.e., duty ratio) therebetween.

Also in the discharge lamp lighting apparatus provided with the half bridge type inverter circuit 131, the power supply circuit for the inverter controller 3, the lamp voltage determiner and the off-state detector can be constituted in the same manner as the first to third embodiments. However, the fourth embodiment of the discharge lamp lighting apparatus is further provided with the boosting chopper voltage regulator 141. The power MOSFET 143 for carrying out the chopper operation is also constituted to be controlled by the inverter controller 3. In the fourth embodiment of the discharge lamp lighting apparatus, when the discharge lamp lighting apparatus has been turned on, the pair of the power MOSFETs 132,133 of the inverter circuit 131 are then activated. Whereby, a high frequency AC voltage is induced in the detection winding 17b of the transformer 17. The induced voltage is then rectified by the second DC power supply circuit 2a, and thus the rectified DC voltage is supplied to the chopper operation power MOSFET 143 of the voltage regulator 141. By the way, the pair of power MOSFETs 132, 133 and the chopper operation power MOSFET 143 can be activated simultaneously.

According to the first aspect of the discharge lamp lighting apparatus, it is able to indirectly determine the lighting state of the discharge lamp according to the high frequency current, which is induced in the detection winding of the transformer and then supplied to the second DC power supply circuit.

Furthermore, according to the first aspect of the invention, since the off-state of the discharge lamp can be detected by utilizing the second DC power supply circuit without necessity of providing a particular circuit for extracting a current from the inverter circuit, the circuit configuration of the discharge lamp lighting apparatus can be simplified and improved the efficiency of the discharge lamp lighting apparatus.

According to the second aspect of the invention, the lamp voltage determiner is able to indirectly determine the lamp voltage of the discharge lamp according to the DC supply voltage of the second DC power supply circuit. Therefore, there is no necessity of providing additional lamp voltage determiner in the inverter circuit, and thus the discharge lamp lighting apparatus can be simplified.

According to the third aspect of the invention, a starting operation for the discharge lamp upon turning-on the discharge lamp lighting apparatus can be securely carried out.

A fourth aspect of the discharge lamp lighting apparatus is characterized by further comprising a voltage limiter for limiting the second DC voltage. With the third aspect of the discharge lamp lighting apparatus provided with the starting circuit for the inverter controller, when a lamp life terminal state, and an off-state of the discharge lamp are detected and the inverter controller is in the standby state, the voltage supplied from the starting circuit in an inverter controller rises suddenly, and there is a possibility that an inverter controller may be damaged. However, according to the fourth aspect of the discharge lamp lighting apparatus, the voltage supplied to an inverter controller is limited below the withstand voltage of the inverter controller.

According to the third aspect of the invention, the control operation of the inverter controller can be defined by the reference voltage.

According to the sixth aspect of the invention, the control operation of the inverter controller can be defined by the reference voltage.

According to the seventh aspect of the invention, in a standby state that the inverter circuit is deactivated, a power supply to a circuit, e.g., an oscillator, not required to be activated is halted, while a power supply to a circuit, e.g., the safeguard, required to be activated is halted for maintaining the standby state. Thus power consumption in the standby state of the inverter controller is depressed in a minimum amount.

According to the eighth aspect of the invention, a timer for managing the preheating period, and a timer for managing the starting period so that an oscillation of the inverter controller may not immediately halt when the discharge lamp has come to a life terminal state or an off-state can be realized by a unitary integrating circuit. Therefore, a specific circuit for detecting starting operation of a discharge lamp becomes unnecessary.

The ninth aspect of the discharge lamp lighting apparatus is characterized by that when the discharge lamp lights up after passing over the preheating period and the starting period, it is controlled by the sixth aspect of the discharge lamp lighting apparatus so that the output oscillation frequency of an inverter controller becomes fixed.

According to the tenth aspect of the discharge lamp lighting apparatus, a favorable dimming can be carried out because the inverter circuit is configured in the half bridge type circuit configuration.

According to the tenth aspect of the discharge lamp lighting apparatus, a higher harmonic interference can be prevented by a low distortion feature and a high power factor feature of the boosting chopper regulator.

According to the tenth aspect of the discharge lamp lighting apparatus, since the voltage of the second DC power supply circuit is secured from the detection winding of the transformer before the chopper operation switching element is started, a reliable operation of the second DC power supply circuit is guaranteed.

While there have been illustrated and described what are at present considered to be preferred embodiments according to the present invention, it will be understood by those skilled in the art that various changes and modifications may be made, and equivalents may be substituted for elements thereof without departing from the true scope according to the present invention. In addition, many modifications may be made to adapt a particular situation or material to the teaching according to the present invention without departing from the central scope thereof. Therefore, it is intended that the present invention not be limited to the particular embodiment disclosed as the best aspect contemplated for carrying out the present invention, but that the present invention includes all embodiments falling within the scope of the appended claims.

The foregoing description and the drawings are regarded by the applicant as including a variety of individually inventive concepts, some of which may lie partially or wholly outside the scope of some or all of the following claims. The fact that the applicant has chosen at the time of filing of the present application to restrict the claimed scope of protection in accordance with the following claims is not to be employed as a disclaimer or alternative inventive concepts that are included in the contents of the application and could be defined by claims differing in scope from the following claims, which different claims may be adopted subsequently during prosecution, for example, for the purposes of a divisional application.

What is claimed is:

1. A discharge lamp lighting apparatus, comprising:
a first DC power supply circuit for converting an AC line voltage to a DC voltage;
an inverter circuit provided with a switching element and a transformer, thereby the DC voltage supplied from the first DC power supply circuit is converted to a high frequency voltage for lighting a discharge lamp by an on-off switching operation of the switching element;
an inverter controller for controlling the high frequency voltage output of the inverter by controlling the on-off switching operation of the switching element;
a second DC power supply circuit for supplying a second DC voltage to the inverter controller through a power input end of the inverter controller, the second DC power supply circuit being provided with a detection winding inductively coupled to the transformer, thereby the second DC voltage being obtained by rectifying an induced current in the detection winding, and
a monitor for monitoring a lighting state of the discharge lamp by checking the DC voltage supplied from the second DC power supply circuit.

2. A discharge lamp lighting apparatus as claimed in claim 1, wherein the monitor is provided with a lamp voltage determiner for determining a lamp voltage of the discharge lamp according to the DC supply voltage of the second DC power supply circuit.

3. A discharge lamp lighting apparatus as claimed in claim 1, further comprising a starting circuit containing a starting resistor connected between the first DC supply circuit and the power input end of the inverter controller, thereby the starting circuit starting the inverter controller upon turning-on the discharge lamp lighting apparatus.

4. A discharge lamp lighting apparatus as claimed in claim 1, further comprising a voltage limiter for limiting the second DC voltage.

5. A discharge lamp lighting apparatus as claimed in claim 1, wherein the inverter controller is further provided with a reference voltage source, generating a reference voltage for defining the control operation of the inverter controller.

6. A discharge lamp lighting apparatus as claimed in claim 5, wherein
the monitor comprises a detector for detecting a life terminal state or an off-state of the discharge lamp, and the reference voltage source comprises a first reference voltage source and a second reference voltage source.

7. A discharge lamp lighting apparatus as claimed in claim 6, further comprising:
a safeguard for halting the inverter circuit when the detector detects the life terminal state or the off-state of the discharge lamp,
wherein the first reference voltage source halts supplying a voltage when the inverter circuit halts, and the second reference voltage source keeps supplying a voltage to the safeguard during the halting of the inverter circuit.

8. A discharge lamp lighting apparatus as claimed in claim 1, wherein
the inverter controller is further provided with an integrating circuit containing a capacitor;
a preheating period of the discharge lamp is defined by a time until the capacitor being charged to a first predetermined voltage;
a starting period of the discharge lamp is defined by a time until the capacitor being further charged to a second predetermined voltage;
a charged voltage of the capacitor is maintained between the first predetermined voltage and the second predetermined voltage when the discharge lamp lights normally; and
the inverter controller halts when the capacitor is charged to a voltage higher than the second predetermined voltage in case of the discharge lamp being in the lamp life terminal state or the off-state of the discharge lamp.

9. A discharge lamp lighting apparatus as claimed in claim 8, wherein the inverter controller varies an output frequency so as to keep the DC voltage of the second DC power supply circuit constant during both periods of the preheating and the starting, and the inverter controller fixes the output frequency after the discharge lamp lights.

10. A discharge lamp lighting apparatus, comprising:
a first DC power supply circuit for converting an AC line voltage to a DC voltage;
a boosting chopper type regulator provided with a series connection of an inductor and a rectifying diode, a chopper transistor connected in parallel with the first DC power supply circuit via the inductor and a smoothing capacitor connected in parallel with the chopper transistor via the rectifying diode;
a half-bridge type inverter circuit provided with a series connection of switching elements connected in parallel with the boosting chopper type regulator and a driving circuit for complementarily switching the switching elements, thereby the DC voltage supplied from the boosting chopper type regulator is converted to a high frequency voltage;
a load circuit provided with a series connection of a transformer, a current-limiting inductor and a DC cutoff capacitor, the series connection being connected in parallel with one of the switching elements of the inverter circuit, and feeding the high frequency voltage output from the half-bridge type inverter circuit to the discharge lamp through the transformer;
an inverter controller for controlling the high frequency voltage output of the inverter by controlling the on-off switching operations of the switching elements;
a second DC power supply circuit provided with a detection winding inductively coupled to the transformer, thereby an induced current in the detection winding being rectified and then supplied to the inverter controller; and
a monitor for monitoring a lighting state of the discharge lamp by checking the voltage of the second DC power supply circuit.
